(19) United States
(12) Patent Application Publication
(10) Pub. No.: US 2022/0236017 A1
(43) Pub. Date: Jul. 28, 2022

(54) REFRIGERANT/HEAT TRANSFER LIQUID HEAT EXCHANGER

(71) Applicant: Valeo Systemes Thermiques, Le Mesnil Saint-Denis (FR)

(72) Inventor: Jugurtha Benouali, Le Mesnil Saint Denis (FR)

(73) Assignee: Valeo Systemes Thermiques, Le Mesnil Saint-Denis (FR)

(21) Appl. No.: 17/612,744

(22) PCT Filed: May 18, 2020
(86) PCT No.: PCT/EP2020/063759

§ 371 Date: Nov. 19, 2021

(30) Foreign Application Priority Data
May 21, 2019 (FR) FR1905305

(51) Int. Cl. F28D 9/00

(52) U.S. Cl. CPC F28D 9/0093; B60H 1/00278; F28D 9/005

(57) ABSTRACT

The present invention relates to a refrigerant/heat transfer liquid heat exchanger (10) comprising at least one stack of plates (105b, 105c, 105d, 105e, 105f) defining at least two heat exchange compartments (41, 42) that are sealed from each other, namely a first heat exchange compartment (41) that includes a first refrigerant circulation path (21a) and a first heat transfer liquid circulation path (22a), and a second heat exchange compartment (42) that includes a second refrigerant circulation path (21b) and a second heat transfer liquid circulation path (22b). At least one of the circulation paths (21a, 22a) of the first heat exchange compartment (41) and one of the circulation paths (22a, 22b) of the second heat exchange compartment (42) are at least partially delimited by a single plate (105b, 105c, 105d, 105e, 105f).

The present invention relates to a refrigerant/heat transfer liquid heat exchanger. The present invention also relates to an installation comprising a refrigerant circuit, a heat transfer liquid circuit and such a refrigerant/heat transfer liquid heat exchanger. The present invention also relates to a method for cooling an electrical storage device of a motor vehicle using such an installation.

In the automotive sector, it is common to have to modify a temperature of a component such as an electric motor, a battery, a heat and/or cold storage device or similar. To this end, the motor vehicle is provided with an installation that comprises a refrigerant circuit inside which a refrigerant circulates, and a heat transfer liquid circuit inside which a heat transfer liquid circulates. The refrigerant circuit comprises a compressor for compressing the refrigerant, a thermal exchanger for cooling the refrigerant at constant pressure, an expansion member to allow the expansion of the refrigerant, and a refrigerant/heat transfer liquid heat exchanger that is arranged to allow a thermal transfer between the refrigerant and the heat transfer liquid. The heat transfer liquid circuit comprises a pump and a thermal exchanger capable of modifying a temperature of the component.

The refrigerant/heat transfer liquid heat exchanger is an exchanger comprising plates that are stacked and joined together in order to form tubes defining refrigerant circulation chambers or heat transfer liquid circulation chambers. The plate comprises four orifices in order to allow the intake and output of the refrigerant, and the intake and output of the heat transfer liquid into and from the circulation chambers situated on either side of a single plate.

The refrigerant/heat transfer liquid heat exchanger is bordered by a first cheek and a second cheek between which the plates are arranged. The first cheek is provided with four passages in order to allow the intake and output of the refrigerant and the intake and output of the heat transfer liquid into and from the circulation chambers situated on either side of a single plate. The second cheek does not have any passages.

It is common to have to cool the component according to different modes, in particular when it comprises at least one electric battery. It is necessary to cool the electric battery when it is charging, during which the electric battery tends to heat up. The electric battery can be charged in rapid charging mode, in which a charging time is short and an electric charging current is high, or in normal charging mode, in which the charging time is long and the electric charging current is low. The heating of the electric battery is generally proportional to the electric charging current.

It is thus common to have to cool the electric battery in rapid charging mode, in which the electric battery dissipates a significant quantity of heat, requiring an equally significant cooling power supplied by the heat exchanger. It is also common to have to cool the electric battery in normal charging mode, in which the electric battery dissipates a small quantity of heat, which a considerably lower cooling power than that necessary in rapid charging mode is sufficient to dissipate.

In order to handle these two separate operating modes, the refrigerant/heat transfer liquid heat exchanger is usually configured to supply the high cooling power that is necessary when the electric battery is in rapid charging mode.

In other words, the refrigerant/heat transfer liquid heat exchanger is designed and configured to supply high cooling power, corresponding to the power necessary to dissipate the heat supplied by the battery in rapid charging mode.

Paradoxically, however, it appears that a refrigerant/heat transfer liquid heat exchanger configured in this way has degraded cooling performance when the cooling power requested is low. In other words, it appears that the refrigerant/heat transfer liquid heat exchanger configured in this way cools the electric battery less well in normal charging mode than it cools this same electric battery in rapid charging mode.

One aim of the present invention is to propose a refrigerant/heat transfer liquid heat exchanger configured to efficiently and rapidly supply the appropriate cooling power as a function of various operating modes of the electric battery.

The present invention improves the situation by proposing a refrigerant/heat transfer liquid heat exchanger having the following technical features.

An exchanger of the present invention is a refrigerant/heat transfer liquid heat exchanger comprising at least one stack of plates defining at least two heat exchange compartments that are sealed from each other, namely a first heat exchange compartment that includes a first refrigerant circulation path and a first heat transfer liquid circulation path, and a second heat exchange compartment that includes a second refrigerant circulation path and a second heat transfer liquid circulation path.

According to the present invention, at least one of the circulation paths of the first heat exchange compartment and one of the circulation paths of the second heat exchange compartment are at least partially delimited by a single plate.

The refrigerant/heat transfer liquid heat exchanger advantageously comprises at least any one of the following technical features, alone or in combination:

the same plate defines the first refrigerant circulation path and the second refrigerant circulation path,

the same plate defines the first heat transfer liquid circulation path and the second heat transfer liquid circulation path,

the same plate jointly defines the first refrigerant circulation path, the first heat transfer liquid circulation path, the second refrigerant circulation path and the second heat transfer liquid circulation path,

the refrigerant/heat transfer liquid heat exchanger and its heat exchange compartments are integrally formed and cannot operate after any separation of the heat exchange compartments from each other,

the heat exchange compartments are sealed from each other in the sense that no fluid, which can equally be refrigerant and/or heat transfer liquid, can travel directly from one of the heat exchange compartments to the other,

the refrigerant circulation paths and the heat transfer liquid circulation paths are arranged so that they allow an exchange of heat energy between the refrigerant suitable for circulating inside the refrigerant circulation paths and the heat transfer liquid intended to circulate inside the heat transfer liquid circulation paths, the respective circulation paths being accommodated inside the first heat exchange compartment or the second heat exchange compartment,

the first heat exchange compartment and the second heat exchange compartment are bordered by a first cheek and a second cheek,

the first cheek is provided with eight passages, a first passage, a second passage, a third passage and a fourth passage of which are assigned to the first heat exchange compartment, and a fifth passage, a sixth passage, a seventh passage and an eighth passage of which are assigned to the second heat exchange compartment, and the second cheek does not have any passages,

the first refrigerant circulation path includes a plurality of first refrigerant circulation chambers, the second refrigerant circulation path includes a plurality of second refrigerant circulation chambers, the first heat transfer liquid circulation path includes a plurality of first heat transfer liquid circulation chambers, the second heat transfer liquid circulation path includes a plurality of second heat transfer liquid circulation chambers, and a single plate jointly defines one of the first refrigerant circulation chambers, one of the second refrigerant circulation chambers, one of the first heat transfer liquid circulation chambers and one of the second heat transfer liquid circulation chambers,

a first refrigerant circulation chamber is interposed between two first heat transfer liquid circulation chambers and a first heat transfer liquid circulation chamber is interposed between two first refrigerant circulation chambers,

a second refrigerant circulation chamber is interposed between two second heat transfer liquid circulation chambers and a second heat transfer liquid circulation chamber is interposed between two second refrigerant circulation chambers,

a first volume of a first refrigerant circulation chamber is between 30% and 50% of a first total volume of a first refrigerant circulation chamber and of a second refrigerant circulation chamber, and said first volume is in particular of the order of one third, to within plus or minus 10%, of said first total volume,

a second volume of a second refrigerant circulation chamber is between 50% and 70% of said first total volume, and said second volume is in particular of the order of two thirds, to within plus or minus 10%, of said first total volume,

a third volume of a first heat transfer liquid circulation chamber is between 30% and 50% of a second total volume of a first heat transfer liquid circulation chamber and of a second heat transfer liquid circulation chamber, and said third volume is in particular of the order of one third, to within plus or minus 10%, of said second total volume,

a fourth volume of a second heat transfer liquid circulation chamber is between 50% and 70% of said second total volume, and the fourth volume of a second heat transfer liquid circulation chamber is in particular of the order of two thirds, to within plus or minus 10%, of said second total volume,

the first volume and the third volume are equal, to within manufacturing tolerances, and the second volume and the fourth volume are equal, to within manufacturing tolerances,

the first volume and the third volume are different, and the second volume and the fourth volume are different,

the sum of the first volume and the second volume is equal to the sum of the third volume and the fourth volume,

the refrigerant/heat transfer liquid heat exchanger comprises at least one manifold extending along a general axis of elongation that is parallel to a plane of separation jointly bordering the first heat exchange compartment and the second heat exchange compartment,

the first heat exchange compartment and the second heat exchange compartment are arranged side by side,

the first heat exchange compartment and the second heat exchange compartment are resting against each other, in contact with each other by means of the plane of separation,

the plane of separation that defines the first heat exchange compartment and the second heat exchange compartment is orthogonal to a first plane in which the first cheek is inscribed and to a second plane in which the second cheek is inscribed,

at least one of the heat exchange compartments comprises four manifolds,

the manifolds allow the intake or discharge of the refrigerant or of the heat transfer liquid inside the refrigerant/heat transfer liquid heat exchanger,

the first heat exchange compartment is provided with four manifolds and the second heat exchange compartment is provided with four manifolds,

two of the manifolds of a single heat exchange compartment are dedicated to the circulation of the refrigerant, and the other two manifolds of the same heat exchange compartment are dedicated to the circulation of the heat transfer liquid,

two of the manifolds of a single heat exchange compartment are in fluid communication with the first refrigerant circulation path and the other two manifolds of the same heat exchange compartment are in fluid communication with the first heat transfer liquid circulation path,

at least one of the manifolds extends from one end to the other of one of the heat exchange compartments along its general axis of elongation, which intersects a bottom plane in which a bottom of the plate extends,

the plate comprises at least one groove that sealably isolates the first heat exchange compartment and the second heat exchange compartment,

the first circulation chambers and the second circulation chambers are stacked along a stacking direction that is parallel to the general axis of elongation of the manifold, at least one circulation chamber, which can equally be the first circulation chamber or the second circulation chamber, being delimited by two immediately adjacent plates and at least the groove of one of these plates,

a refrigerant circulation chamber is interposed between two heat transfer liquid circulation chambers and a heat transfer liquid circulation chamber is interposed between two refrigerant circulation chambers,

a first refrigerant circulation chamber is interposed between two first heat transfer liquid circulation chambers and a first heat transfer liquid circulation chamber is interposed between two first refrigerant circulation chambers,

a second refrigerant circulation chamber is interposed between two second heat transfer liquid circulation chambers and a second heat transfer liquid circulation chamber is interposed between two second refrigerant circulation chambers,

each plate includes a raised edge made up of two longitudinal edges and two lateral edges and surrounding the bottom, which is provided with eight orifices,

the plates are assembled with each other by brazing of at least their raised edges,

the eight orifices comprise four orifices, a first orifice, a second orifice, a third orifice and a fourth orifice of which are arranged inside a first zone of the plate, and four other orifices, a fifth orifice, a sixth orifice, a seventh orifice and an eighth orifice of which are arranged inside a second zone of the plate, the first zone and the second zone being separated from each other by the groove, which originates from the bottom of the plate and extends between a first lateral edge and a second lateral edge of the plate,

the first zone constitutes the first heat exchange compartment and the second zone constitutes the second heat exchange compartment,

the groove is parallel to the first longitudinal edge and to the second longitudinal edge,

a first zone width taken perpendicularly between a first longitudinal edge and the groove is between 30% and 50% of a plate width taken perpendicularly between the first longitudinal edge and the second longitudinal edge, and the first zone width is in particular of the order of one third, to within plus or minus 10%, of the plate width,

a second zone width taken perpendicularly between the groove and the second longitudinal edge is between 50% and 70% of the plate width, and the second zone width is in particular of the order of two thirds, to within plus or minus 10%, of the plate width,

according to a first embodiment, a first manifold and a third manifold constitute the first heat transfer liquid circulation path, the second manifold and the fourth manifold constitute the first refrigerant circulation path, the fifth manifold and the seventh manifold constitute the second refrigerant circulation path, and the seventh manifold and the eighth manifold constitute the second heat transfer liquid circulation path,

the first refrigerant circulation path and the first heat transfer liquid circulation path are I-shaped,

the second refrigerant circulation path and the second heat transfer liquid circulation path are I-shaped,

according to a second embodiment, the first manifold and the second manifold constitute the first heat transfer liquid circulation path, the third manifold and the fourth manifold constitute the first refrigerant circulation path, the fifth manifold and the sixth manifold constitute the second heat transfer liquid circulation path, and the seventh manifold and the eighth manifold constitute the second refrigerant circulation path,

the first refrigerant circulation path and the first heat transfer liquid circulation path are U-shaped,

the second refrigerant circulation path and the second heat transfer liquid circulation path are U-shaped,

the first orifice has a first diameter, the second orifice has a second diameter, the third orifice has a third diameter and the fourth orifice has a fourth diameter, the fifth orifice has a fifth diameter, the sixth orifice has a sixth diameter, the seventh orifice has a seventh diameter and the eighth orifice has an eighth diameter,

according to a first embodiment, the first diameter, the third diameter, the sixth diameter and the eighth diameter are equal, the second diameter and the fifth diameter are equal, and the fourth diameter and the seventh diameter are equal and are larger than the second diameter and the fifth diameter,

in this case, the second orifice is an orifice for taking refrigerant into the first heat exchange compartment, the fourth orifice is an orifice for discharging refrigerant from the first heat exchange compartment, the fifth orifice is an orifice for taking refrigerant into the second heat exchange compartment and the seventh orifice is an orifice for discharging refrigerant from the second heat exchange compartment,

according to a second embodiment, the first diameter and the third diameter are equal, the sixth diameter and the eighth diameter are equal, the second diameter is smaller than the fourth diameter, and the fifth diameter is smaller than the seventh diameter,

in this case, the second orifice is an orifice for taking refrigerant into the first heat exchange compartment, the fourth orifice is an orifice for discharging refrigerant from the first heat exchange compartment, the fifth orifice is an orifice for taking refrigerant into the second heat exchange compartment and the seventh orifice is an orifice for discharging refrigerant from the second heat exchange compartment,

according to a third embodiment, the first diameter, the third diameter, the sixth diameter and the eighth diameter are equal, the second diameter is larger than the fourth diameter, and the fifth diameter is larger than the seventh diameter,

in this case, the second orifice is an orifice for discharging refrigerant from the first heat exchange compartment, the fourth orifice is an orifice for taking refrigerant into the first heat exchange compartment, the fifth orifice is an orifice for discharging refrigerant from the second heat exchange compartment and the seventh orifice is an orifice for taking refrigerant into the second heat exchange compartment,

the bottom of the plate is provided with at least one rib that extends inside the first zone and/or the second zone,

these arrangements are such that a circulation of the refrigerant and of the heat transfer liquid are I-shaped and are either co-current or counter-current,

the rib is substantially perpendicular to the groove, and preferably the rib is perpendicular to the groove,

the rib is substantially parallel to the groove, and preferably the rib is parallel to the groove,

according to a first variant, a first recess extends parallel to the lateral edges from one of the longitudinal edges to a first recess free end, and a second recess extends parallel to the lateral edges from one of the longitudinal edges to a second recess free end,

the first recess extends from the first longitudinal edge to the first recess end, which is situated at a non-zero distance from the groove, and the second recess extends from the first longitudinal edge to the second recess end, which is situated at a non-zero distance from the groove,

these arrangements are such that a circulation of the refrigerant and of the heat transfer liquid are U-shaped and are co-current,

the first recess extends from the groove to the first recess end, which is situated at a non-zero distance from the first longitudinal edge, and the second recess extends from the groove to the second recess end, which is situated at a non-zero distance from the first longitudinal edge,

these arrangements are such that a circulation of the refrigerant and of the heat transfer liquid are U-shaped and are co-current,

according to a second variant, the first recess extends parallel to the longitudinal edges from one of the lateral edges to the first recess end, and the second recess extends parallel to the longitudinal edges from one of the lateral edges to the second recess end,

the first recess extends from the first lateral edge to the first recess end, which is situated at a non-zero distance from the second lateral edge, and the second recess extends from the first lateral edge to the second recess end, which is situated at a non-zero distance from the second lateral edge,

the first recess extends from the second lateral edge to the first recess end, which is situated at a non-zero distance from the first lateral edge, and the second recess extends from the second lateral edge to the second recess end, which is situated at a non-zero distance from the first lateral edge,

these arrangements are such that a circulation of the refrigerant and of the heat transfer liquid are U-shaped and are counter-current.

The present invention also relates to an installation for thermal treatment of a component provided on a motor vehicle, the installation comprising a refrigerant circuit, a heat transfer liquid circuit and such a refrigerant/heat transfer liquid heat exchanger, the refrigerant circuit comprising a first refrigerant circulation branch and a second refrigerant circulation branch that are arranged parallel to each other, the heat transfer liquid circuit comprising a first heat transfer liquid circulation branch and a second heat transfer liquid circulation branch that are arranged parallel to each other, the first refrigerant circulation path constituting the first refrigerant circulation branch, the first heat transfer liquid circulation path constituting the first heat transfer liquid circulation branch, the second refrigerant circulation path constituting the second refrigerant circulation branch and the second heat transfer liquid circulation path constituting the second heat transfer liquid circulation branch,

in other words, the first refrigerant circulation branch comprises the first refrigerant circulation path, the first heat transfer liquid circulation branch comprises the first heat transfer liquid circulation path, the second refrigerant circulation branch comprises the second refrigerant circulation path and the second heat transfer liquid circulation branch comprises the second heat transfer liquid circulation path.

The present invention also relates to a method for cooling an electrical storage device of a motor vehicle using such an installation, in which:

the refrigerant and the heat transfer liquid travel through the first heat exchange compartment and the second heat exchange compartment when the electrical storage device is in a rapid charging mode,

the refrigerant and the heat transfer liquid travel through the first heat exchange compartment only when the electrical storage device is in a normal charging mode,

the refrigerant and the heat transfer liquid travel through the second heat exchange compartment only when the electrical storage device is in an intermediate charging mode,

it will be understood that in rapid charging mode, a charging time of the electrical storage device is short and an electric charging current of the electrical storage device is high, in normal charging mode of the electrical storage device, the charging time is long and the electric charging current is low, and in intermediate charging mode of the electrical storage device, the charging time is between the short charging time and the long charging time and the electric charging current is between the low charging current and the high charging current.

The invention will be better understood on reading the following non-limiting description, given with reference to the appended drawings, in which:

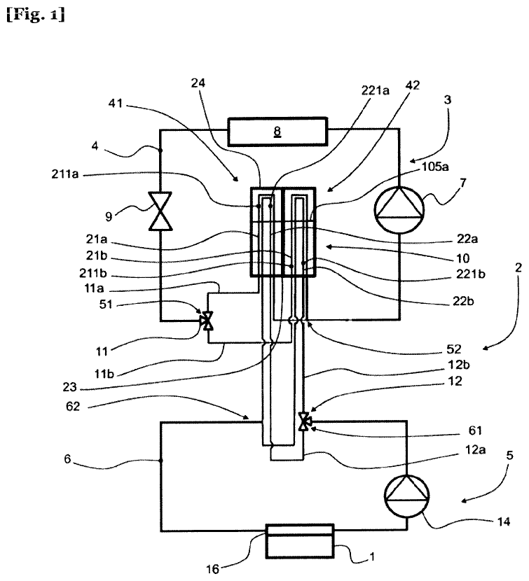

FIG. 1 shows a first variant of an installation of the present invention, according to a first mode for cooling a component.

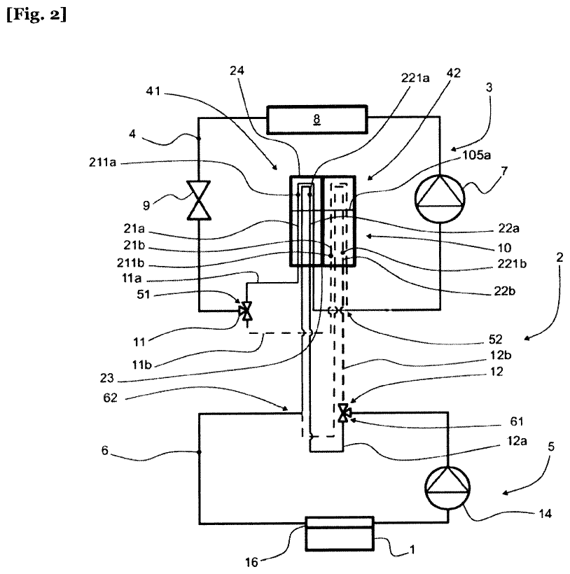

FIG. 2 shows the installation according to the first variant illustrated in FIG. 1 and according to a second mode for cooling the component.

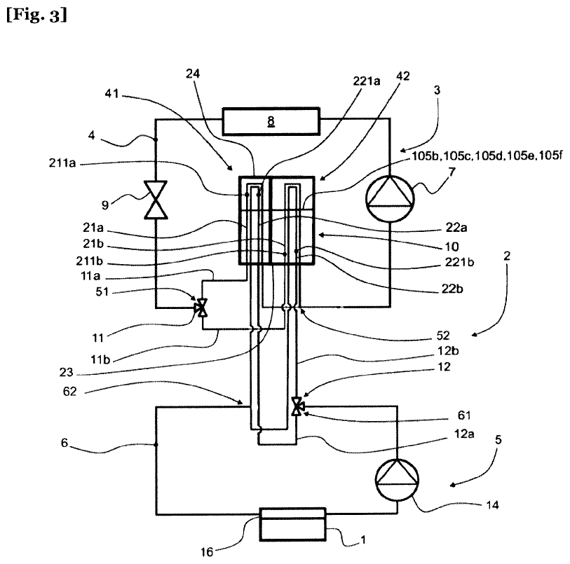

FIG. 3 shows a second variant of an installation of the present invention, according to the first mode for cooling a component.

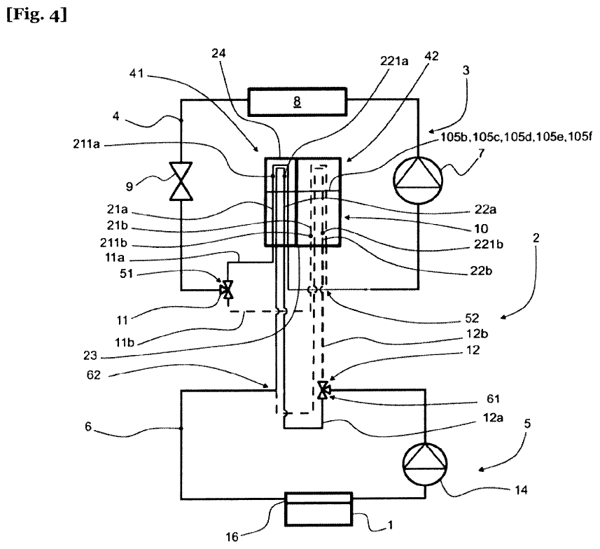

FIG. 4 shows the installation according to the second variant illustrated in figure 3 and according to the second mode for cooling the component.

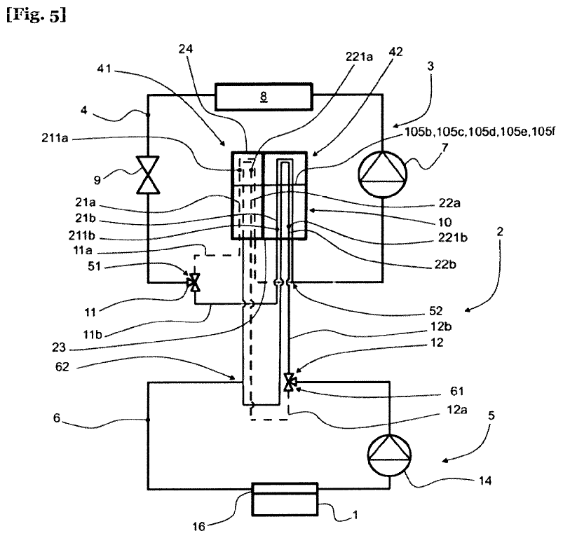

FIG. 5 shows the installation according to the second variant illustrated in figures 3 and 4 and according to a third mode for cooling the component.

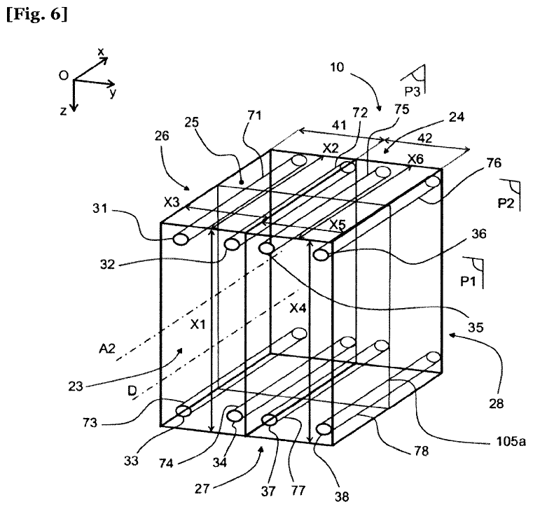

FIG. 6 is a perspective view of a first variant of a refrigerant/heat transfer liquid heat exchanger of the present invention, which constitutes the installation illustrated in FIGS. 1 and 2.

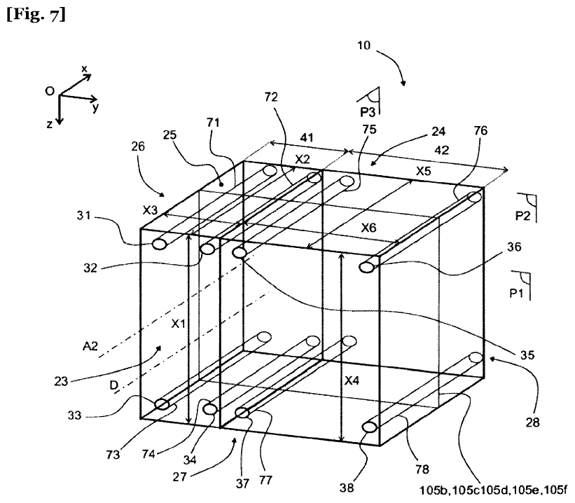

FIG. 7 is a perspective view of a second variant of a refrigerant/heat transfer liquid heat exchanger of the present invention, which constitutes the installation illustrated in FIGS. 3 to 5.

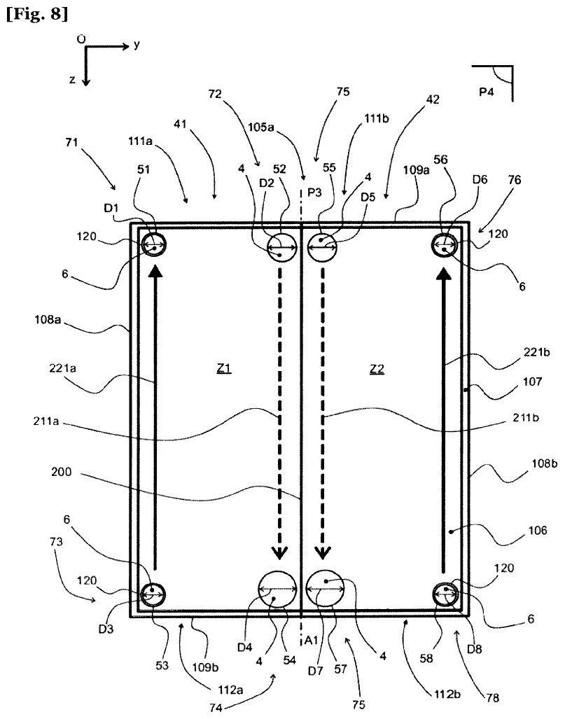

FIG. 8 schematically shows a front view of a first type of plate constituting the refrigerant/heat transfer liquid heat exchanger shown in FIG. 6.

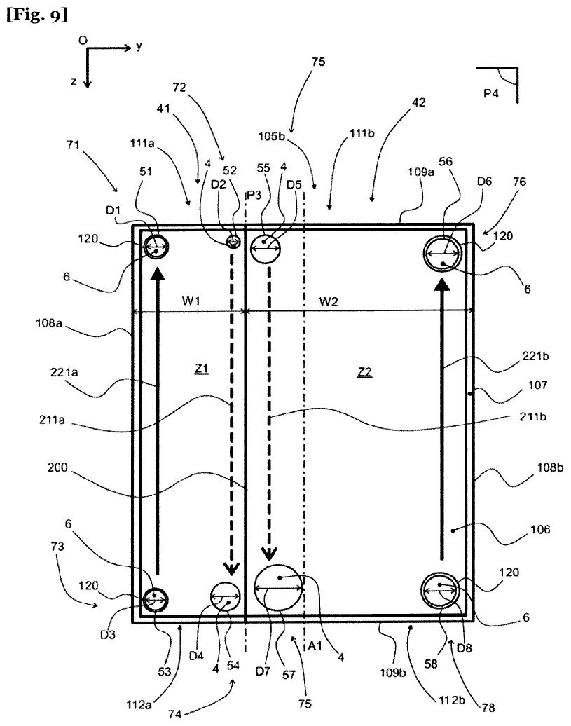

FIG. 9 schematically shows a front view of a second type of plate constituting a first embodiment of the refrigerant/heat transfer liquid heat exchanger shown in FIG. 7.

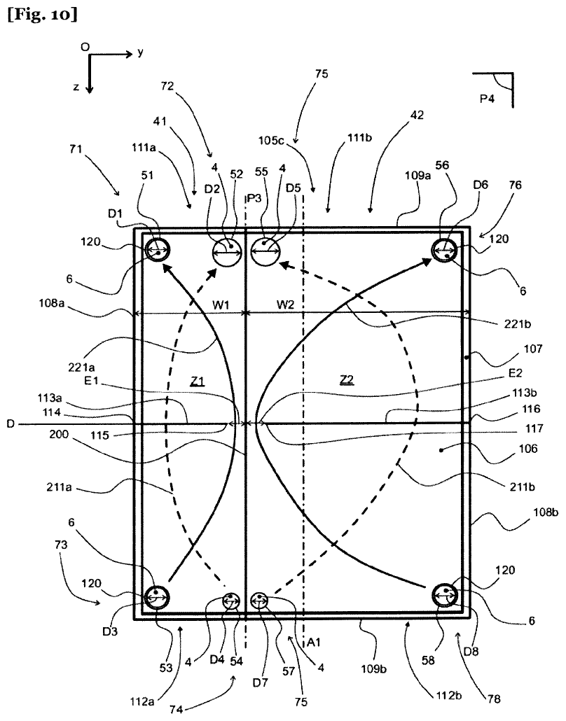

FIG. 10 schematically shows a front view of a third type of plate constituting a second embodiment of the refrigerant/heat transfer liquid heat exchanger shown in FIG. 7.

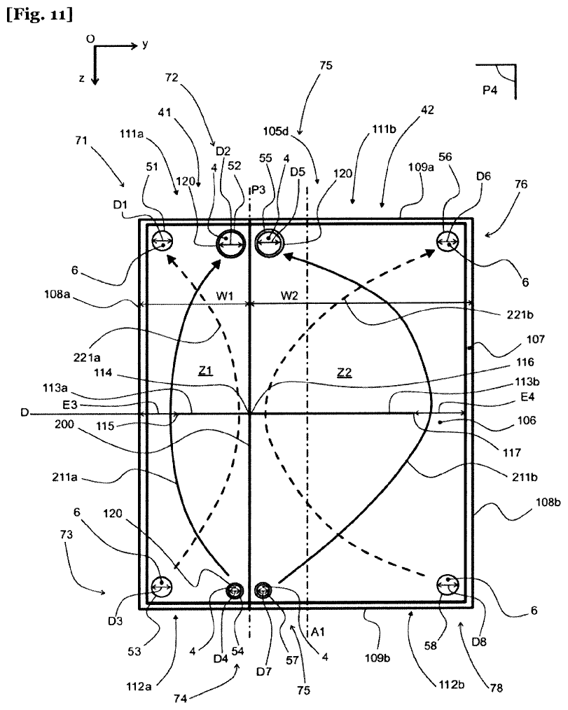

FIG. 11 schematically shows a front view of a fourth type of plate constituting the second embodiment of the refrigerant/heat transfer liquid heat exchanger shown in FIG. 7.

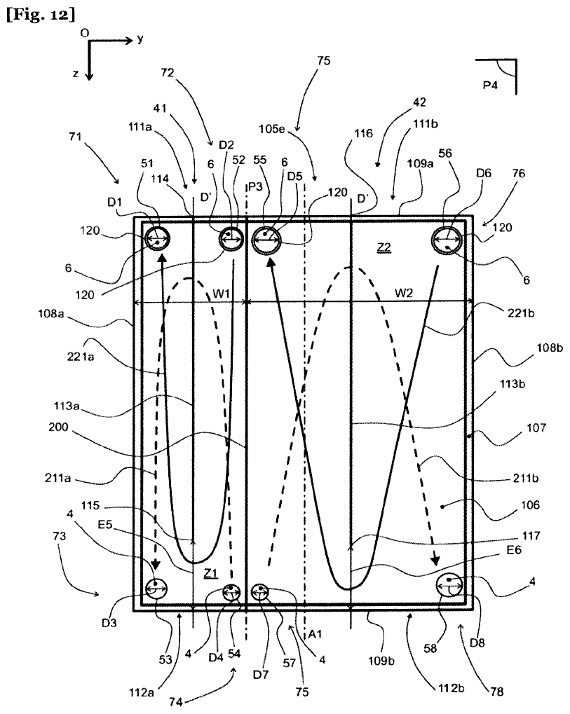

FIG. 12 schematically shows a front view of a fifth type of plate constituting a third embodiment of the refrigerant/heat transfer liquid heat exchanger shown in FIG. 7.

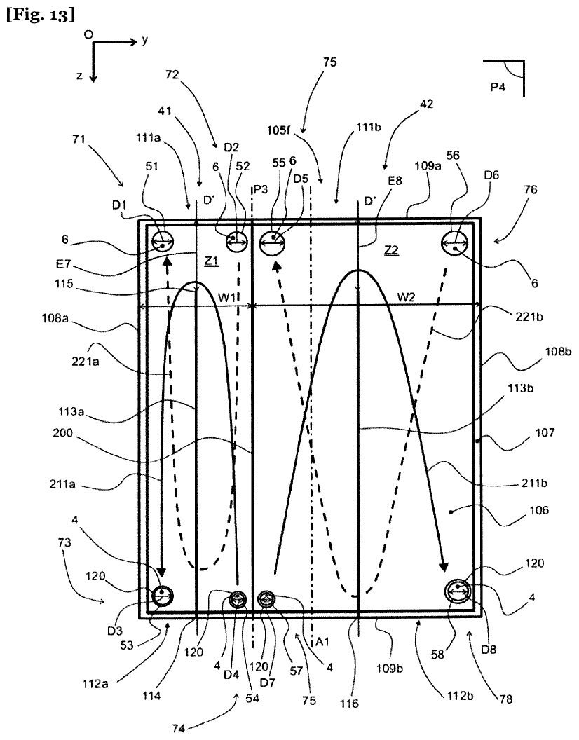

FIG. 13 schematically shows a front view of a sixth type of plate constituting the third embodiment of the refrigerant/heat transfer liquid heat exchanger shown in FIG. 7.

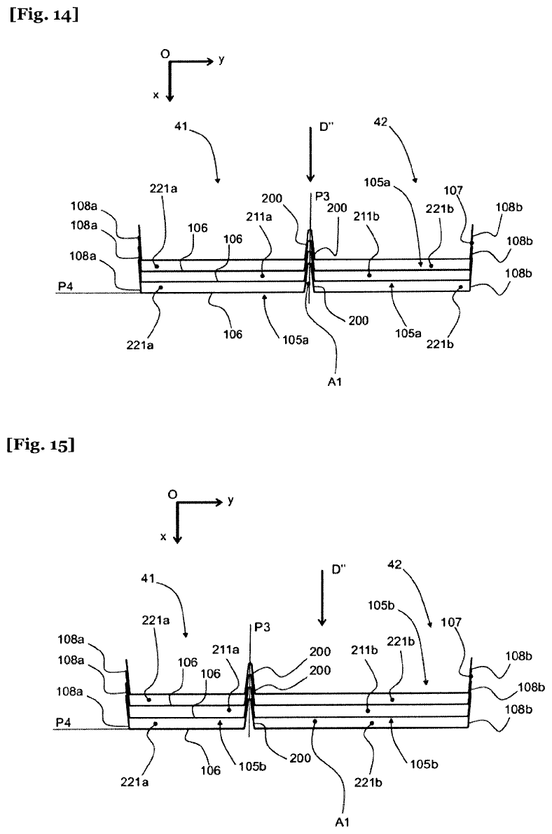

FIG. 14 schematically shows a lateral cross-section of four plates illustrated in FIG. 8 assembled with each other.

FIG. 15 schematically shows a lateral cross-section of four plates illustrated in FIG. 9 assembled with each other.

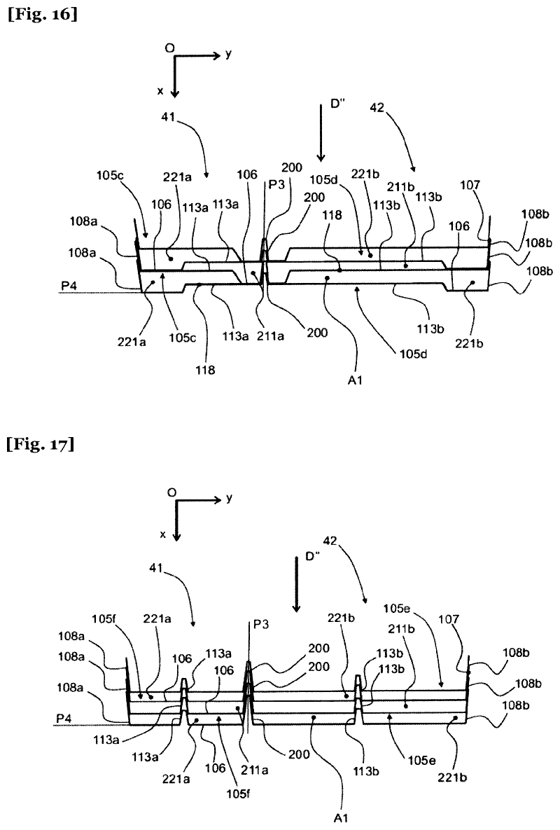

FIG. 16 schematically shows a lateral cross-section of four plates, two of which are plates of the third type illustrated in FIG. 10 and two of which are plates of the fourth type illustrated in FIG. 11, assembled with each other to form the refrigerant/heat transfer liquid heat exchanger shown in FIG. 7.

FIG. 17 schematically shows a lateral cross-section of four plates, two of which are plates of the fifth type illustrated in FIG. 12 and two of which are plates of the sixth type illustrated in FIG. 13, assembled with each other to form the refrigerant/heat transfer liquid heat exchanger shown in FIG. 7.

In FIGS. 1 to 5, a motor vehicle is provided with a component 1 which must be cooled or heated, for example in order to optimize the operation thereof. Such a component i is for example an electric motor or internal combustion engine suitable for at least partially propelling the motor vehicle, an electrical storage device comprising at least one electric battery intended to store electrical energy, a device for storing heat and/or cold energy, or similar. The component i is more particularly an electrical storage device comprising at least one electric battery that can be charged in particular in rapid charging mode, in which a charging time is short and an electric charging current is high, or in normal charging mode, in which the charging time is long and the electric charging current is low. The present invention aims to efficiently cool the electric battery, regardless of its charging mode: rapid charging mode in which the battery heats up rapidly and significantly, as shown in FIGS. 1 and 3, normal charging mode in which the electric battery heats up slowly and slightly, as shown in FIGS. 2 and 4, or intermediate charging mode in which the battery heats up moderately, in particular more than in normal charging mode and less than in rapid charging mode, as shown in FIG. 5.

To this end, the motor vehicle is provided with an installation 2 that comprises a refrigerant circuit 3 inside which a refrigerant 4 circulates, for example carbon dioxide or similar, and a heat transfer liquid circuit 5 inside which a heat transfer liquid 6 circulates, in particular glycol water or similar. The installation 2 is configured to modify a temperature of the component 1, and in particular to cool the component 1.

The installation 2 comprises at least one refrigerant/heat transfer liquid heat exchanger 10 according to the present invention. The installation 2 is described below in order to better understand the present invention, but the features of the installation 2 described do not limit the refrigerant/heat transfer liquid heat exchanger 10 of the present invention. In other words, the installation 2 is able to have distinct structural features and/or operating modes different from those described, without the refrigerant/heat transfer liquid heat exchanger 10 departing from the rules of the present invention.

The refrigerant circuit 3 successively comprises a compressor 7 for compressing the refrigerant 4, a refrigerant/external air exchanger 8 for cooling the refrigerant 4 at constant pressure, for example placed on the front face of the motor vehicle, an expansion member 9 to allow the expansion of the refrigerant 4, a first member 11 for controlling a supply of refrigerant 4 to the refrigerant/heat transfer liquid heat exchanger 10 and the refrigerant/heat transfer liquid heat exchanger 10, which is arranged to allow a thermal transfer between the refrigerant 4 and the heat transfer liquid 6.

The first control member 11 is capable of directing the refrigerant 4 coming from the expansion member 9 towards at least any one of a first refrigerant circulation branch 11a and a second refrigerant circulation branch 11b comprised in the refrigerant circuit 3, the first refrigerant circulation branch 11a and the second refrigerant circulation branch 11b being arranged parallel to each other. The first refrigerant circulation branch 11a and the second refrigerant circulation branch 11b are formed parallel between a first point of the refrigerant circuit 51 and a second point of the refrigerant circuit 52. The first point of the refrigerant circuit 51 is situated between the expansion member 9 and the refrigerant/heat transfer liquid heat exchanger 10, while the second point of the refrigerant circuit 52 is placed between the refrigerant/heat transfer liquid heat exchanger 10 and the compressor 7.

The first point of the refrigerant circuit 51 is provided with the first member 11 for controlling the supply of refrigerant 4 to the refrigerant/heat transfer liquid heat exchanger 10. According to another variant, the second point of the refrigerant circuit 52 is provided with the first member 11 for controlling the supply of refrigerant 4 to the refrigerant/heat transfer liquid heat exchanger 10. The refrigerant/heat transfer liquid heat exchanger 10 constitutes the first refrigerant circulation branch 11a and the second refrigerant circulation branch 11b.

The first control member 11 comprises, for example, a three-way valve or any other control means permitting or prohibiting the supply of refrigerant 4 to the first refrigerant circulation branch 11a and/or to the second refrigerant circulation branch 11b.

The heat transfer liquid circuit 5 successively comprises a pump 14 to cause the heat transfer liquid 6 to circulate inside the heat transfer liquid circuit 5, a second member 12 for controlling the supply of heat transfer liquid 6 to the refrigerant/heat transfer liquid heat exchanger 10, which also constitutes the refrigerant circuit 3, and a thermal exchanger 16, the thermal exchanger 16 being capable of modifying a temperature of the component 1, in particular by direct contact formed between the component 1 and the thermal exchanger 16.

The second control member 12 is capable of directing the heat transfer liquid 6 coming from the pump 14 towards at least any one of a first heat transfer liquid circulation branch 12a and a second heat transfer liquid circulation branch 12b comprised in the heat transfer liquid circuit 5, the first heat transfer liquid circulation branch 12a and the second heat transfer liquid circulation branch 12b being arranged parallel to each other. The first heat transfer liquid circulation branch 12a and the second heat transfer liquid circulation branch 12b are formed parallel between a first point of the heat transfer liquid circuit 61 and a second point of the heat transfer liquid circuit 62. The first point of the heat transfer liquid circuit 61 is situated between pump 14 and the refrigerant/heat transfer liquid heat exchanger 10, while the second point of the heat transfer liquid circuit 62 is placed between the refrigerant/heat transfer liquid heat exchanger 10 and the thermal exchanger 16.

The first point of the heat transfer liquid circuit 61 is provided with the second member 12 for controlling a supply of heat transfer liquid 6 to the refrigerant/heat transfer liquid heat exchanger 10. According to another variant, the second point of the heat transfer liquid circuit 62 is provided with second member 12 for controlling a supply of heat transfer liquid 6 to the refrigerant/heat transfer liquid heat exchanger 10. The refrigerant/heat transfer liquid heat exchanger 10 constitutes the first heat transfer liquid circulation branch 12a and the second heat transfer liquid circulation branch 12b.

The second control member 12 comprises, for example, a three-way valve or any other control means permitting or prohibiting the supply of heat transfer liquid 6 to the first heat transfer liquid circulation branch 12a and/or to the second heat transfer liquid circulation branch 12b.

In order to constitute the first refrigerant circulation branch 11a and the second refrigerant circulation branch 11b as well as the first heat transfer liquid circulation branch 12a and the second heat transfer liquid circulation branch 12b, the refrigerant/heat transfer liquid heat exchanger 10 has a particular structure and layout.

The refrigerant/heat transfer liquid heat exchanger 10 comprises at least two refrigerant circulation paths 21a, 21b and at least two heat transfer liquid circulation paths 22a, 22b.

More particularly, the refrigerant/heat transfer liquid heat exchanger 10 comprises at least a first refrigerant circulation path 21a and a second refrigerant circulation path 21b. The first refrigerant circulation path 21a and the second refrigerant circulation path 21b are arranged parallel to each other inside the refrigerant/heat transfer liquid heat exchanger 10. The first refrigerant circulation path 21a thus forms an integral part of the first refrigerant circulation branch 11a and the second refrigerant circulation path 21b forms an integral part of the second refrigerant circulation branch 11b.

Likewise, the refrigerant/heat transfer liquid heat exchanger 10 comprises at least a first heat transfer liquid circulation path 22a and a second heat transfer liquid circulation path 22b. The first heat transfer liquid circulation path 22a and the second heat transfer liquid circulation path 22b are arranged parallel to each other inside the refrigerant/heat transfer liquid heat exchanger 10. The first heat transfer liquid circulation path 22a thus forms an integral part of the first heat transfer liquid circulation branch 12a and the second heat transfer liquid circulation path 22b forms an integral part of the second heat transfer liquid circulation branch 12b.

The first refrigerant circulation path 21a and the first heat transfer liquid circulation path 22a are arranged so that the refrigerant 4 present inside the first refrigerant circulation path 21a exchanges heat energy with the heat transfer liquid 6 present inside the first heat transfer liquid circulation path 22a.

Likewise, the second refrigerant circulation path 21b and the second heat transfer liquid circulation path 22b are arranged so that the refrigerant 4 present inside the second refrigerant circulation path 21b exchanges heat energy with the heat transfer liquid 6 present inside the second heat transfer liquid circulation path 22b.

The first refrigerant circulation path 21a includes a plurality of first refrigerant circulation chambers 211a and the first heat transfer liquid circulation path 22a includes a plurality of first heat transfer liquid circulation chambers 221a, a first refrigerant circulation chamber 211a being interposed between two first heat transfer liquid circulation chambers 221a and a first heat transfer liquid circulation chamber 221a being interposed between two first refrigerant circulation chambers 211a.

The second refrigerant circulation path 21b includes a plurality of second refrigerant circulation chambers 211b and the second heat transfer liquid circulation path 22b includes a plurality of second heat transfer liquid circulation chambers 221b, a second refrigerant circulation chamber 211b being interposed between two second heat transfer liquid circulation chambers 221b and a second heat transfer liquid circulation chamber 221b being interposed between two second refrigerant circulation chambers 211b.

The refrigerant/heat transfer liquid heat exchanger 10 is an exchanger that comprises a first heat exchange compartment 41 extending between a first cheek 23 and a second cheek 24 and a second heat exchange compartment 42 that also extends between the first cheek 23 and the second cheek 24. In other words, the first heat exchange compartment 41 and the second heat exchange compartment 42 are both delimited by the first cheek 23 and the second cheek 24. The refrigerant/heat transfer liquid heat exchanger 10 is made up of two heat exchange compartments 41, 42 that are sealed from each other and that are positioned side by side and both bordered by the first cheek 23 and the second cheek 24.

The first cheek 23 and the second cheek 24 consist of end plates of the refrigerant/heat transfer liquid heat exchanger 10, the first cheek 23 and the second cheek 24 being parallel to each other.

The first heat exchange compartment 41 houses the first refrigerant circulation path 21a and the first heat transfer liquid circulation path 22a, while the second heat exchange compartment 42 houses the second refrigerant circulation path 21b and the second heat transfer liquid circulation path 22b.

The refrigerant/heat transfer liquid heat exchanger 10 is a one-piece heat exchanger in the sense that the heat exchange compartments 41, 42 constituting the refrigerant/heat transfer liquid heat exchanger 10 can only be separated from each other by dislocating and/or destroying at least one of the heat exchange compartments 41, 42.

According to a first variant illustrated in FIGS. 1 and 2, the first heat exchange compartment 41 has a volume that is half, to within 10%, of the total volume of the refrigerant/heat transfer liquid heat exchanger 10, and the second heat exchange compartment 42 has a volume that is the other half, to within 10%, of the total volume of the refrigerant/heat transfer liquid heat exchanger 10.

In FIG. 1, the component 1 is in rapid charging mode and requires significant cooling power. The first control member ii thus permits the circulation of the refrigerant 4 towards the first refrigerant circulation branch 11a and towards the second refrigerant circulation branch 11b, so that the refrigerant 4 travels through the entire volume of the refrigerant/heat transfer liquid heat exchanger 10. Likewise, the second control member 12 permits the circulation of the heat transfer liquid 6 towards the first heat transfer liquid circulation branch 12a and towards the second heat transfer liquid circulation branch 12b, so that the heat transfer liquid 6 travels through the entire volume of the refrigerant/heat transfer liquid heat exchanger 10. These arrangements are such that an exchange surface between the refrigerant circulation paths 21a, 21b and the heat transfer liquid circulation paths 22a, 22b is as large as possible, in order to optimize the cooling of the heat transfer liquid 6, and consequently of the component 1.

In FIG. 2, the component 1 is in normal charging mode and requires low cooling power, less than the significant cooling power. The first control member 11 thus permits the circulation of the refrigerant 4 towards one of the refrigerant circulation branches 11a, 11b, for example the first refrigerant circulation branch 11a, and prohibits the circulation of the refrigerant 4 towards the other of the refrigerant circulation branches 11a, 11b, for example the second refrigerant circulation branch 11b, so that the refrigerant 4 travels through the first heat exchange compartment 41 of the refrigerant/heat transfer liquid heat exchanger 10 only. Likewise, the second control member 12 permits the circulation of the heat transfer liquid 6 towards one of the heat transfer liquid circulation branches 12a, 12b, for example the first heat transfer liquid circulation branch 12a, and prohibits the circulation of the heat transfer liquid 6 towards the other of the heat transfer liquid circulation branches 12a, 12b, for example the second heat transfer liquid circulation branch 12b, so that the heat transfer liquid 6 travels through the first heat exchange compartment 41 of the refrigerant/heat transfer liquid heat exchanger 10 only. These arrangements are such that an exchange surface between the refrigerant circulation paths 21a, 21b and the heat transfer liquid circulation paths 22a, 22b is minimal, in order to cool the heat transfer liquid 6 according to the cooling requirement of the component 1, which is less than when it is in rapid charging mode.

These arrangements are such that the refrigerant/heat transfer liquid heat exchanger 10 configured in this way and associated with the first control member 11 and the second control member 12 is capable of efficiently and rapidly supplying the appropriate cooling power as a function of the two aforementioned operating modes of the component 1.

According to a variant illustrated in figures 3 to 5, the first heat exchange compartment 41 has a volume that is one third, to within 10%, of a total volume of the refrigerant/heat transfer liquid heat exchanger 10, while the second heat exchange compartment 42 has a volume that is two thirds, to within 10%, of the total volume of the refrigerant/heat transfer liquid heat exchanger 10.

In FIG. 3, the component 1 is in rapid charging mode and requires significant cooling power. The first control member 11 thus permits the circulation of the refrigerant 4 towards the first refrigerant circulation branch 11a and towards the second refrigerant circulation branch 11b, so that the refrigerant 4 travels through the entire volume of the refrigerant/heat transfer liquid heat exchanger 10. Likewise, the second control member 12 permits the circulation of the heat transfer liquid 6 towards the first heat transfer liquid circulation branch 12a and towards the second heat transfer liquid circulation branch 12b, so that the heat transfer liquid 6 travels through the entire volume of the refrigerant/heat transfer liquid heat exchanger 10. These arrangements are such that an exchange surface between the refrigerant circulation paths 21a, 21b and the heat transfer liquid circulation paths 22a, 22b is as large as possible, in order to optimize the cooling of the heat transfer liquid 6, and consequently of the component 1.

In FIG. 4, the component 1 is in normal charging mode and requires low cooling power, less than the significant cooling power. The first control member 11 thus prohibits the circulation of the refrigerant 4 towards the second refrigerant circulation branch 11b and permits the circulation of the refrigerant 4 towards the first refrigerant circulation branch 11a, so that the refrigerant 4 travels through the first heat exchange compartment 41 of the refrigerant/heat transfer liquid heat exchanger 10 only. Likewise, the second control member 12 prohibits the circulation of the heat transfer liquid 6 towards the second heat transfer liquid circulation branch 12b and permits the circulation of the heat transfer liquid 6 towards the first heat transfer liquid circulation branch 12a, so that the heat transfer liquid 6 travels through the first heat exchange compartment 41 of the refrigerant/heat transfer liquid heat exchanger 10 only. These arrangements are such that an exchange surface between the refrigerant circulation paths 21a, 21b and the heat transfer liquid circulation paths 22a, 22b is minimal, in order to cool the heat transfer liquid 6 according to the cooling requirement of the component 1, which is less than when it is in rapid charging mode.

In FIG. 5, the component 1 is in intermediate charging mode and requires moderate cooling power, greater than the low cooling power and less than the significant cooling power. The first control member ii thus permits the circulation of the refrigerant 4 towards the second refrigerant circulation branch 11b and prohibits the circulation of the refrigerant 4 towards the first refrigerant circulation branch 11a, so that the refrigerant 4 travels through the second heat exchange compartment 42 of the refrigerant/heat transfer liquid heat exchanger 10 only. Likewise, the second control member 12 permits the circulation of the heat transfer liquid 6 towards the second heat transfer liquid circulation branch 12b and prohibits the circulation of the heat transfer liquid 6 towards the first heat transfer liquid circulation branch 12a, so that the heat transfer liquid 6 travels through the second heat exchange compartment 42 of the refrigerant/heat transfer liquid heat exchanger 10 only. These arrangements are such that an exchange surface between the refrigerant circulation paths 21a, 21b and the heat transfer liquid circulation paths 22a, 22b is moderate, in order to cool the heat transfer liquid 6 according to the cooling requirement of the component 1, which is less than when it is in rapid charging mode and is greater than that necessary when the component 1 is in normal charging mode.

These arrangements are such that the refrigerant/heat transfer liquid heat exchanger 10 configured in this way and associated with the first control member 11 and the second control member 12 is capable of efficiently and rapidly supplying the appropriate cooling power as a function of the three aforementioned operating modes of the component 1.

In FIGS. 6 and 7, the refrigerant/heat transfer liquid heat exchanger 10 is shown schematically in an orthonormal frame of reference Oxyz related to the refrigerant/heat transfer liquid heat exchanger 10, in which a direction Ox is a transverse direction, a direction Oy is a lateral direction and a direction Oz is a longitudinal direction. The refrigerant/heat transfer liquid heat exchanger 10 is generally parallelepipedal and extends transversely between the first cheek 23 and the second cheek 24, which transversely border the refrigerant/heat transfer liquid heat exchanger 10. The first cheek 23 extends mainly inside a first plane P1 that is parallel to the plane Oyz. The second cheek 24 extends mainly inside a second plane P2 that is also parallel to the plane Oyz.

In other words, the refrigerant/heat transfer liquid heat exchanger 10 is transversely delimited by the first cheek 23 on one side and the second cheek 24 on the other side. More particularly, the first heat exchange compartment 41 and the second heat exchange compartment 42 are jointly transversely delimited by the first cheek 23 on one side and the second cheek 24 on the other side. It will be understood from this that the first heat exchange compartment 41 and the second heat exchange compartment 42 are laterally positioned side by side. In yet other words, a plane of separation P3 that defines the first heat exchange compartment 41 and the second heat exchange compartment 42 is orthogonal to the first plane P1 and to the second plane P2 and is parallel to a plane Oxz.

The first cheek 23 is provided with eight passages 31, 32, 33, 34, 35, 36, 37, 38, which are preferably circular. It will be understood that the first passage 31, the second passage 32, the third passage 33, the fourth passage 34, the fifth passage 35, the sixth passage 36, the seventh passage 37 and the eighth passage 38 are for example each made up of an orifice allowing the circulation of the refrigerant 4 or the heat transfer liquid 6 through the first cheek 23.

A first passage 31, a second passage 32, a third passage 33 and a fourth passage 34 are assigned to the first heat exchange compartment 41.

The first passage 31 and the second passage 32 are aligned in a direction parallel to the direction Oy and are situated near a first side 25 of the refrigerant/heat transfer liquid heat exchanger 10, parallel to the plane Oxy. The first passage 31 is situated near a first flank 26 of the refrigerant/heat transfer liquid heat exchanger 10, the first flank 26 extending in a plane parallel to the plane Oxz. The second passage 32 is situated near the plane of separation P3 interposed between the first heat exchange compartment 41 and the second heat exchange compartment 42. The first flank 26 and the plane of separation P3 laterally border the first heat exchange compartment 41.

The third passage 33 and the fourth passage 34 are aligned in a direction parallel to the direction Oy and are situated near a second side 27 of the refrigerant/heat transfer liquid heat exchanger 10, parallel to the plane Oxy. The second side 27 and the first side 25 vertically border the refrigerant/heat transfer liquid heat exchanger 10. The third passage 33 is situated near the first flank 26 of the refrigerant/heat transfer liquid heat exchanger 10. The fourth passage 34 is situated near the plane of separation P3 interposed between the first heat exchange compartment 41 and the second heat exchange compartment 42.

A fifth passage 35, a sixth passage 36, a seventh passage 37 and an eighth passage 38 are assigned to the second heat exchange compartment 42.

The fifth passage 35 and sixth passage 36 are aligned in a direction parallel to the direction Oy and are situated near the first side 25 of the refrigerant/heat transfer liquid heat exchanger 10, parallel to the plane Oxy. The fifth passage 35 is situated near the plane of separation P3. The sixth passage 36 is situated near a second flank 28 of the refrigerant/heat transfer liquid heat exchanger 10. The second flank 28 is parallel to the first flank 26 and to the plane Oxz.

The seventh passage 37 and eighth passage 38 are aligned in a direction parallel to the direction Oy and are situated near a second side 27 of the refrigerant/heat transfer liquid heat exchanger 10. The seventh passage 37 is situated near the plane of separation P3. The eighth passage 38 is situated near the second flank 28 of the refrigerant/heat transfer liquid heat exchanger 10.

The first passage 31, the third passage 33, the sixth passage 36 and the eighth passage 38 are arranged at respective corners of the first cheek 23, which is generally rectangular.

The first passage 31 and the third passage 33 are aligned in a direction parallel to the direction Oz, the second passage 32 and the fourth passage 34 are also aligned in a direction parallel to the direction Oz, the fifth passage 35 and the seventh passage 37 are also aligned in a direction parallel to the direction Oz, and the sixth passage 36 and the eighth passage 38 are aligned in a direction parallel to the direction Oz.

The first passage 31 gives access to a first manifold 71, the second passage 32 gives access to a second manifold 72, the third passage 33 gives access to a third manifold 73, the fourth passage 34 gives access to a fourth manifold 74, the fifth passage 35 gives access to a fifth manifold 75, the sixth passage 36 gives access to a sixth manifold 76, the seventh passage 37 gives access to a seventh manifold 77 and the eighth passage 38 gives access to an eighth manifold 78. The manifolds 71, 72, 73, 74, 75, 76, 77, 78 extend along a respective general axis of elongation A2 which is parallel to the axis Ox and perpendicular to the first plane P1 and to the second plane P2. The manifolds 71, 72, 73, 74, 75, 76, 77, 78 are suitable for supplying refrigerant 4 or heat transfer liquid 6 to the chambers 211a, 211b, 221a, 221b. The first manifold 71, the second manifold 72, the third manifold 73 and the fourth manifold 74 are assigned to the first heat exchange compartment 41. The fifth manifold 75, the sixth manifold 76, the seventh manifold 77 and the eighth manifold 78 are assigned to the second heat exchange compartment 42.

The first heat exchange compartment 41 is generally parallelepipedal and extends over a first compartment height X1 taken between the first side 25 and the second side 27 parallel to the axis Oz. The first heat exchange compartment 41 extends over a first compartment length X2 taken between the first cheek 23 and the second cheek 24 parallel to the axis Ox. The first heat exchange compartment 41 extends over a first compartment width X3 taken between the first flank 26 and the plane of separation P3 parallel to the axis Oy.

The second heat exchange compartment 42 is generally parallelepipedal and extends over a second compartment height X4 taken between the first side 25 and the second side 27 parallel to the axis Oz. The second heat exchange compartment 42 extends over a second compartment length X5 taken between the first cheek 23 and the second cheek 24 parallel to the axis Ox. The second heat exchange compartment 42 extends over a second compartment width X6 taken between the plane of separation P3 and the second flank 28 parallel to the axis Oy.

The first compartment height X1 and the second compartment height X4 are equal, to within manufacturing tolerances, and the first compartment length X2 and the second compartment length X5 are equal, to within manufacturing tolerances.

In FIG. 6, which shows the refrigerant/heat transfer liquid heat exchanger 10 of the installation 2 illustrated in FIGS. 1 and 2, the first compartment width X3 is equal to the second compartment width X6, to within manufacturing tolerances.

The refrigerant/heat transfer liquid heat exchanger 10 is a plate exchanger that comprises the first cheek 23, the second cheek 24 and a plurality of plates of a first type 105a, which are interposed between the first cheek 23 and the second cheek 24. The first cheek 23, the second cheek 24 and the plates of the first type 105a are for example brazed together to form the heat exchange compartments 41, 42 of the refrigerant/heat transfer liquid heat exchanger 10.

In FIG. 7, which shows the refrigerant/heat transfer liquid heat exchanger 10 of the installation 2 illustrated in figures 3 to 5, the first compartment width X3 is equal to half of the second compartment width X6, to within manufacturing tolerances.

The refrigerant/heat transfer liquid heat exchanger 10 is a plate exchanger that comprises the first cheek 23, the second cheek 24 and either a plurality of plates of a second type 105b, or a plurality of plates of a third type 105c and a fourth type 105d, or a plurality of plates of a fifth type 105e and a sixth type 105f, which are interposed between the first cheek 23 and the second cheek 24. The first cheek 23, the second cheek 24 and the aforementioned plates 105b, 105c, 105d, 105e, 105f are for example brazed together to form the heat exchange compartments 41, 42 of the refrigerant/heat transfer liquid heat exchanger 10.

Advantageously, and equally for a refrigerant/heat transfer liquid heat exchanger 10 shown in either FIG. 6 or FIG. 7, a single plate 105a, 105b, 105c, 105d, 105e, 105f defines at least one of the first circulation paths 21a, 22a of the first heat exchange compartment 41 and one of the second circulation paths 22a, 22b of the second heat exchange compartment 42.

Preferably, a single plate 105a, 105b, 105c, 105d, 105e, 105f defines the two first circulation paths 21a, 22a of the first heat exchange compartment 41 and the two second circulation paths 22a, 22b of the second heat exchange compartment 42.

Preferably, a single plate 105a, 105b, 105c, 105d, 105e, 105f jointly defines one of the first refrigerant circulation chambers 211a, one of the second refrigerant circulation chambers 211b, one of the first heat transfer liquid circulation chambers 221a and one of the second heat transfer liquid circulation chambers 221b.

In FIGS. 8 to 17, each plate 105a, 105b, 105c, 105d, 105e, 105f extends mainly along an axis of elongation A1. Each plate 105a, 105b, 105c, 105d, 105e, 105f comprises a bottom 106, and at least one raised edge 107 which surrounds the bottom 106. In other words, the raised edge 107 is formed on the periphery of the bottom 106, which extends inside a bottom plane P4, and the raised edge 107 surrounds the bottom 106. It will be understood that each exchange plate 105a, 105b, 105c, 105d, 105e, 105f is arranged in the form of a generally rectangular tub, the bottom of the tub consisting of the bottom 106, and the edges of the tub consisting of the raised edge 107. More particularly, the raised edge 107 comprises two longitudinal raised edges 108a, 108b which are formed opposite each other, and two lateral raised edges 109a, 109b which are formed opposite each other. The longitudinal raised edges 108a, 108b are parallel to the axis of elongation A1, while the lateral raised edges 109a, 109b are orthogonal to the axis of elongation A1.

In FIGS. 8 to 13, each plate 105a, 1015b, 105c, 105d, 105e, 105f comprises eight orifices 51, 52, 53, 54, 55, 56, 57, 58, in particular circular, a first orifice 51 having a first diameter Di, a second orifice 52 having a second diameter D2, a third orifice 53 having a third diameter D3 and a fourth orifice 54 having a fourth diameter D4 of which are arranged inside a first zone Z1 of the plate 15a, 105b, 105c, 105d, 105e, 105f and a fifth orifice 55 having a fifth diameter D5, a sixth orifice 56 having a sixth diameter D6, a seventh orifice 57 having a seventh diameter D7 and an eighth orifice 58 having an eighth diameter D8 of which are positioned inside a second zone Z2 of the plate 105a, 105b, 105c, 105d, 105e, 105f, the first zone Z1 and the second zone Z2 being separated from each other by a groove 200. The groove 200 is formed in the bottom 106 of the plate 105a, 105b, 105c, 105d, 105e, 105f and extends between the first lateral edge 109a and the second lateral edge 109b. The groove 200 is parallel to the axis of elongation A1 and to the longitudinal raised edges 108a, 108b.

The first zone Z1 is arranged in a quadrilateral, in particular rectangular, and is bordered by a first longitudinal raised edge 108a, the groove 200, a first portion ma of the first lateral edge and a first portion 112a of the second lateral edge.

The second zone Z2 is also arranged in a quadrilateral, in particular rectangular, and is bordered by a second longitudinal raised edge 108b, the groove 200, a second portion nib of the first lateral edge and a second portion 112b of the second lateral edge.

The first portion ma of the first lateral edge and the second portion nib of the first lateral edge are separated from each other by the groove 200. The first portion 112a of the second lateral edge and the second portion 112b of the second lateral edge are also separated from each other by the groove 200.

The first portion 111a of the first lateral edge and the second portion 111b of the first lateral edge together form the first lateral edge 109a. The first portion 112a of the second lateral edge and the second portion 112b of the second lateral edge together form the second lateral edge 109b.

The first zone Z1 constitutes the first heat exchange compartment 41 and the second zone Z2 constitutes the second heat exchange compartment 42. The groove 200 thus sealably isolates the first heat exchange compartment 41 and the second heat exchange compartment 42.

The first orifice 51, the second orifice 52, the third orifice 53 and the fourth orifice 54 are respectively distributed at each of the corners of the first zone Z1. Two of these orifices 51, 52, 53, 54 are configured to communicate with one of the first circulation chambers 211a, 221a formed on one side of the bottom io6, and another two of these orifices 51, 52, 53, 54 are configured to communicate with the other of the first circulation chambers 211a, 221a formed on another side of the bottom 106. To this end, two of these orifices 51, 52, 53, 54 are provided with a collar 120 and the other two of these orifices 51, 52, 53, 54 are not provided with a collar. As a result, two of these orifices 51, 52, 53, 54 encircled by these collars 120 extend in a plane offset relative to the bottom plane P4, parallel to the plane Oyz, in which the bottom 106 is inscribed. The other two of these orifices 51, 52, 53, 54 extend in the bottom plane P4.

The fifth orifice 55, the sixth orifice 56, the seventh orifice 57 and the eighth orifice 58 are respectively distributed at each of the corners of the second zone Z2. Two of these orifices 55, 56, 57, 58 are configured to communicate with one of the second circulation chambers 211b, 221b formed on one side of the bottom io6, and another two of these orifices 55, 56, 57, 58 are configured to communicate with the other of the first circulation chambers 211b, 221b formed on another side of the bottom io6. To this end, two of these orifices 55, 56, 57, 58 are provided with a collar 120 and the other two of these orifices 55, 56, 57, 58 are not provided with a collar. As a result, two of these orifices 55, 56, 57, 58 encircled by these collars 120 extend in a plane offset relative to the bottom plane P4, parallel to the plane Oyz, in which the bottom io6 is inscribed. The other two of these orifices 55, 56, 57, 58 extend in the bottom plane P4.

The first orifices 51 of the plates 105a, 105b, 105c, 105d, 105e, 105f are formed opposite each other when these plates 105a, 105b, 105c, 105d, 105e, 105f are assembled with each other, so that peripheral rims of these first orifices 51 together define the first manifold 71. The second orifices 52 of the plates 105a, 105b, 105c, 105d, 105e, 105f are formed opposite each other when these plates 105a, 105b, 105c, 105d, 105e, 105f are assembled with each other, so that peripheral rims of these second orifices 52 together define the second manifold 72. The third orifices 53 of the plates 105a, 105b, 105c, 105d, 105e, 105f are formed opposite each other when these plates 105a, 105b, 105c, 105d, 105e, 105f are assembled with each other, so that peripheral rims of these third orifices 53 together define the third manifold 73. The fourth orifices 54 of the plates 105a, 105b, 105c, 105d, lose, 105f are formed opposite each other when these plates 105a, 105b, 105c, 105d, lose, 105f are assembled with each other, so that peripheral rims of these fourth orifices 54 together define the first manifold 71. The fifth orifices 55 of the plates 105a, 105b, 105c, 105d, lose, 105f are formed opposite each other when these plates 105a, 105b, 105c, 105d, lose, 105f are assembled with each other, so that peripheral rims of these fifth orifices 55 together define the fifth manifold 75. The sixth orifices 56 of the plates 105a, 105b, 105c, 105d, 105e, 105f are formed opposite each other when these plates 105a, 105b, 105c, 105d, 105e, 105f are assembled with each other, so that peripheral rims of these sixth orifices 56 together define the sixth manifold 76. The seventh orifices 57 of the plates 105a, 105b, 105c, 105d, 105e, 105f are formed opposite each other when these plates 105a, 105b, 105c, 105d, 105e, 105f are assembled with each other, so that peripheral rims of these seventh orifices 57 together define the seventh manifold 77. The eighth orifices 58 of the plates 105a, 105b, 105c, 105d, 105e, 105f are formed opposite each other when these plates 105a, 105b, 105c, 105d, 105e, 105f are assembled with each other, so that peripheral rims of these eighth orifices 58 together define the eighth manifold 78.

In FIG. 8, which illustrates a plate of the first type 105a, the groove 200 is formed equidistant from the two longitudinal raised edges 108a, 108b. The first zone Z1 and the second zone Z2 have equal surface areas, to within manufacturing tolerances. The plate of the first type 105a constitutes the refrigerant/heat transfer liquid heat exchanger 10 shown in FIG. 6.

The four orifices provided with a collar 120, namely the first orifice 51 and the third orifice 53 for those in the first zone Z1, and the sixth orifice 56 and the eighth orifice 58 for those in the second zone Z2, are formed near a respective lateral edge 109a, 109b that are longitudinally opposite each other. These arrangements are such that the circulation chambers 211a, 211b, 221a, 221b are each I-shaped. The plate of the first type 105a in the stack of plates that immediately succeeds the plate of the first type 105a illustrated is identical to the one described with reference to FIG. 8, with the exception that the first orifice 51, the third orifice 53, the sixth orifice 56 and the eighth orifice 58 are not provided with a collar, while the second orifice 52, the fourth orifice 54, the fifth orifice 55 and the seventh orifice 57 are provided with a collar 120, in order to seal the circulation chambers 211a, 211b, 221a, 221b from each other, a collar 120 of a plate of the first type 105a being in contact with the bottom 106 of the immediately successive plate of the first type 105a.

The first diameter Di, the third diameter D3, the sixth diameter D6 and the eighth diameter D8 are equal to each other. The first manifold 71, the third manifold 73, the sixth manifold 76 and the eighth manifold 78, which originate from the orifices the diameters of which have the aforementioned features, are in particular manifolds inside which the heat transfer liquid 6 circulates. According to the example illustrated, the third manifold 73 is a manifold for taking the heat transfer liquid 6 into the first heat exchange compartment 41, while the first manifold 71 is a manifold for discharging the heat transfer liquid 6 from the first heat exchange compartment 41. Likewise, the eighth manifold 78 is a manifold for taking the heat transfer liquid 6 into the second heat exchange compartment 42, while the sixth manifold 76 is a manifold for discharging the heat transfer liquid 6 from the second heat exchange compartment 42.

The second diameter D2 is smaller than the fourth diameter D4 and the fifth diameter D5 is smaller than the seventh diameter D7. The second manifold 72, the fourth manifold 74, the fifth manifold 75 and the seventh manifold 77, which originate from the orifices the diameters of which have the aforementioned features, are in particular manifolds inside which the refrigerant 4 circulates. According to the example illustrated, the second manifold 72 is a manifold for taking the refrigerant 4 into the first heat exchange compartment 41, while the fourth manifold 74 is a manifold for discharging the refrigerant 4 from the first heat exchange compartment 41. Likewise, the fifth manifold 75 is a manifold for taking the refrigerant 4 into the second heat exchange compartment 42, while the seventh manifold 77 is a manifold for discharging the refrigerant 4 from the second heat exchange compartment 42.

These arrangements are such that the heat transfer liquid 6 and the refrigerant 4 circulate counter-currently to each other inside the first heat exchange compartment 41 and the second heat exchange compartment 42.

By reversing the direction of circulation of the heat transfer liquid 6 inside the first manifold 71 and the third manifold 73 and/or the sixth manifold 76 and the eighth manifold 78, a refrigerant/heat transfer liquid heat exchanger 10 is obtained inside which the heat transfer liquid 6 and the refrigerant 4 circulate co-currently with each other inside the first heat exchange compartment 41 and the second heat exchange compartment 42.

In FIGS. 9 to 13, which respectively illustrate a plate of the second type 105b, a plate of the third type 105c, a plate of the fourth type 105d, a plate of the fifth type 105e and a plate of the sixth type 105f, the groove 200 is formed at a first distance W1 from the first longitudinal raised edge 108a that is equal to half of a second distance W2 taken between the groove 200 and the second longitudinal edge 108b, these distances W1, W2 being taken orthogonally to the longitudinal raised edges 108a, 108b and to the groove 200. The first zone Z1 has a surface area that is equal to half of a surface area of the second zone Z2, to within manufacturing tolerances.

FIG. 9 illustrates a plate of the second type 105b, which constitutes the refrigerant/heat transfer liquid heat exchanger 10 shown in FIG. 7.

The four orifices provided with a collar 120, namely the first orifice 51 and the third orifice 53 for those in the first zone Z1, and the sixth orifice 56 and the eighth orifice 58 for those in the second zone Z2, are formed near a respective lateral edge 109a, 109b that are longitudinally opposite each other. These arrangements are such that the circulation chambers 211a, 211b, 221a, 221b are each I-shaped. The plate of the second type 105b in the stack of plates that immediately succeeds the plate of the second type 105b illustrated is identical to the one described with reference to FIG. 9, with the exception that the first orifice 51, the third orifice 53, the sixth orifice 56 and the eighth orifice 58 are not provided with a collar, while the second orifice 52, the fourth orifice 54, the fifth orifice 55 and the seventh orifice 57 are provided with a collar 120, in order to seal the circulation chambers 211a, 211b, 221a, 221b from each other, a collar 120 of a plate of the second type 105b being in contact with the bottom 106 of the immediately successive plate of the second type 105b.

The first diameter Di, the third diameter D3, the sixth diameter D6 and the eighth diameter D8 are equal to each other. The first manifold 71, the third manifold 73, the sixth manifold 76 and the eighth manifold 78, which originate from the orifices the diameters of which have the aforementioned features, are in particular manifolds inside which the heat transfer liquid 6 circulates. According to the example illustrated, the third manifold 73 is a manifold for taking the heat transfer liquid 6 into the first heat exchange compartment 41, while the first manifold 71 is a manifold for discharging the heat transfer liquid 6 from the first heat exchange compartment 41. Likewise, the eighth manifold 78 is a manifold for taking the heat transfer liquid 6 into the second heat exchange compartment 42, while the sixth manifold 76 is a manifold for discharging the heat transfer liquid 6 from the second heat exchange compartment 42.

The second diameter D2 is smaller than the fourth diameter D4 and the fifth diameter D5 is smaller than the seventh diameter D7. The second manifold 72, the fourth manifold 74, the fifth manifold 75 and the seventh manifold 77, which originate from the orifices the diameters of which have the aforementioned features, are in particular manifolds inside which the refrigerant 4 circulates. According to the example illustrated, the second manifold 72 is a manifold for taking the refrigerant 4 into the first heat exchange compartment 41, while the fourth manifold 74 is a manifold for discharging the refrigerant 4 from the first heat exchange compartment 41. Likewise, the fifth manifold 75 is a manifold for taking the refrigerant 4 into the second heat exchange compartment 42, while the seventh manifold 77 is a manifold for discharging the refrigerant 4 from the second heat exchange compartment 42.

These arrangements are such that the heat transfer liquid 6 and the refrigerant 4 circulate counter-currently to each other inside the first heat exchange compartment 41 and the second heat exchange compartment 42. By reversing the direction of circulation of the heat transfer liquid 6 inside the first manifold 71 and the third manifold 73 and/or the sixth manifold 76 and the eighth manifold 78, a refrigerant/heat transfer liquid heat exchanger 10 is obtained inside which the heat transfer liquid 6 and the refrigerant 4 circulate co-currently with each other inside the first heat exchange compartment 41 and the second heat exchange compartment 42.

FIG. 10 illustrates a plate of the third type 105c, which constitutes the refrigerant/heat transfer liquid heat exchanger 10 shown in FIG. 7, alternately superposed with a plate of the fourth type 105d illustrated in FIG. 11.

The bottom 106 of a plate of the third type 105c and the bottom 106 of a plate of the fourth type 105d comprise ribs 111a, 113b that are arranged so that the circulation chambers 211a, 211b, 221a, 221b have a U-shaped profile. The ribs 113a, 113b are formed in a first direction D that is preferably parallel to the lateral raised edges 109a, 109b. In other words, the first direction D is preferably orthogonal to the axis of elongation A1 of the exchange plate of the third type 105c and the plate of the fourth type 105d. A first rib 113a is formed inside the first zone Z1 and a second rib 113b is formed inside the second zone Z2.

In FIG. 10, the first rib 113a of the plate of the third type 105c extends between a first rib first end 114 and a first rib second end 115, the first rib first end 114 being in contact with the raised edge 107, and preferably in contact with the first longitudinal raised edge 108a. The first rib second end 115 is situated with a first non-zero gap E1 between it and the groove 200, the first gap E1 being taken along the first direction D between the first rib second end 115 and the groove 200.

The second rib 113b of the plate of the third type 105c extends between a second rib first end 116 and a second rib second end 117, the second rib first end 116 being in contact with the raised edge 107, and preferably in contact with the second longitudinal raised edge 108b. The second rib second end 117 is situated with a second non-zero gap E2 between it and the groove 200, the second gap E2 being taken along the first direction D between the second rib second end 117 and the groove 200.

The four orifices provided with a collar 120, namely the first orifice 51 and the third orifice 53 for those in the first zone Z1, and the sixth orifice 56 and the eighth orifice 58 for those in the second zone Z2, are formed near a respective lateral edge 109a, 109b that are longitudinally opposite each other.

In FIG. 11, the first rib 113a of the plate of the fourth type 105d extends between a first rib first end 114 and a first rib second end 115, the first rib first end 114 being in contact with the groove 200. The first rib second end 115 is situated with a third non-zero gap E3 between it and the first longitudinal raised edge 108a, the third gap E3 being taken along the first direction D between the first rib second end 115 and the first longitudinal raised edge 108a.

The second rib 113b of the plate of the fourth type 105d extends between a second rib first end 116 and a second rib second end 117, the second rib first end 116 being in contact with the groove 200. The second rib second end 117 is situated with a fourth non-zero gap E4 between it and the second longitudinal raised edge 108b, the second gap E2 being taken along the first direction D between the second rib second end 117 and the second longitudinal raised edge 108b.

The four orifices provided with a collar 120, namely the second orifice 52 and the fourth orifice 54 for those in the first zone Z1, and the fifth orifice 55 and the seventh orifice 57 for those in the second zone Z2, are formed near a respective lateral edge 109a, 109b that are longitudinally opposite each other.

The collars 120 of a plate of the third type 105c are in contact with the bottom 106 of the immediately successive plate of the fourth type 105d and the collars 120 of a plate of the fourth type 105d are in contact with the bottom 106 of the immediately successive plate of the third type 105c.

In FIGS. 10 and 11, the first diameter D1, the third diameter D3, the sixth diameter D6 and the eighth diameter D8 are equal to each other. The first manifold 71, the third manifold 73, the sixth manifold 76 and the eighth manifold 78, which originate from the orifices the diameters of which have the aforementioned features, are in particular manifolds inside which the heat transfer liquid 6 circulates. According to the example illustrated, the third manifold 73 is a manifold for taking the heat transfer liquid 6 into the first heat exchange compartment 41, while the first manifold 71 is a manifold for discharging the heat transfer liquid 6 from the first heat exchange compartment 41. Likewise, the eighth manifold 78 is a manifold for taking the heat transfer liquid 6 into the second heat exchange compartment 42, while the sixth manifold 76 is a manifold for discharging the heat transfer liquid 6 from the second heat exchange compartment 42.

The second diameter D2 is larger than the fourth diameter D4 and the fifth diameter D5 is larger than the seventh diameter D7. The second manifold 72, the fourth manifold 74, the fifth manifold 75 and the seventh manifold 77, which originate from the orifices the diameters of which have the aforementioned features, are in particular manifolds inside which the refrigerant 4 circulates. According to the example illustrated, the fourth manifold 74 is a manifold for taking the refrigerant 4 into the first heat exchange compartment 41, while the second manifold 72 is a manifold for discharging the refrigerant 4 from the first heat exchange compartment 41. Likewise, the seventh manifold 77 is a manifold for taking the refrigerant 4 into the second heat exchange compartment 42, while the fifth manifold 75 is a manifold for discharging the refrigerant 4 from the second heat exchange compartment 42.

These arrangements are such that the heat transfer liquid 6 and the refrigerant 4 circulate co-currently with each other inside the first heat exchange compartment 41 and the second heat exchange compartment 42.

By reversing the direction of circulation of the heat transfer liquid 6 inside the first manifold 71 and the third manifold 73 and/or the sixth manifold 76 and the eighth manifold 78, a refrigerant/heat transfer liquid heat exchanger 10 is obtained inside which the heat transfer liquid 6 and the refrigerant 4 circulate counter-currently to each other inside the first heat exchange compartment 41 and the second heat exchange compartment 42.

FIG. 12 illustrates a plate of the fifth type 105e, which constitutes the refrigerant/heat transfer liquid heat exchanger 10 shown in FIG. 7, alternately superposed with a plate of the sixth type 105e illustrated in FIG. 13.

The bottom 106 of a plate of the fifth type 105e and the bottom 106 of a plate of the sixth type 105f comprise ribs 113a, 113b that are arranged so that the circulation chambers 211a, 211b, 221a, 221b have a U-shaped profile. The ribs 113a, n3b are formed in a second direction D′ that is preferably parallel to the longitudinal raised edges 108a, 108b. In other words, the second direction D′ is for example parallel to the axis of elongation A1 of the exchange plate of the fifth type 105e and the plate of the sixth type 105f. A first rib 113a is formed inside the first zone Z1 and a second rib 113b is formed inside the second zone Z2.

In FIG. 12, the first rib 113a of the plate of the fifth type 105e extends between a first rib first end 114 and a first rib second end 115, the first rib first end 114 being in contact with the raised edge 107, and preferably in contact with the first lateral raised edge 109a. The first rib second end 115 is situated with a fifth non-zero gap E5 between it and the second lateral raised edge 109b, the fifth gap E5 being taken along the second direction D′ between the first rib second end 115 and the second lateral raised edge 109b.

The second rib 113b of the plate of the fifth type 105e extends between a second rib first end 116 and a second rib second end 117, the second rib first end 116 being in contact with the raised edge 107, and preferably in contact with the first lateral raised edge 109a. The second rib second end 117 is situated with a sixth non-zero gap E6 between it and the second lateral raised edge 109b, the sixth gap E6 being taken along the second direction D′ between the second rib second end 117 and the second lateral raised edge 109b.

The four orifices provided with a collar 120, namely the first orifice 51 and the second orifice 52 for those in the first zone Z1, and the fifth orifice 55 and the sixth orifice 56 for those in the second zone Z2, are formed near the first lateral raised edge 109a.

In FIG. 13, the first rib 113a of the plate of the sixth type 105f extends between a first rib first end 114 and a first rib second end 115, the first rib first end 114 being in contact with the second lateral raised edge 109b. The first rib second end 115 is situated with a seventh non-zero gap E7 between it and the first lateral raised edge 109a, the seventh gap E7 being taken along the second direction D′ between the first rib second end 115 and the first lateral raised edge 109a.

The second rib 113b of the plate of the sixth type 105f extends between a second rib first end 116 and a second rib second end 117, the second rib first end 116 being in contact with the second lateral raised edge 109b. The second rib second end 117 is situated with an eighth non-zero gap E8 between it and the first lateral raised edge 109a, the eighth gap E8 being taken along the second direction D′ between the second rib second end 117 and the first lateral raised edge 109a.

The four orifices provided with a collar 120, namely the third orifice 53 and the fourth orifice 54 for those in the first zone Z1, and the seventh orifice 57 and the eighth orifice 58 for those in the second zone Z2, are formed near the second lateral raised edge 109b.

The collars 120 of a plate of the fifth type 105e are in contact with the bottom 106 of the immediately successive plate of the sixth type 105f and the collars 120 of a plate of the sixth type 105f are in contact with the bottom 106 of the immediately successive plate of the fifth type 105e.

In FIGS. 12 and 13, the first diameter Di, the third diameter D3, the sixth diameter D6 and the eighth diameter D8 are equal to each other. The first manifold 71, the third manifold 73, the sixth manifold 76 and the eighth manifold 78, which originate from the orifices the diameters of which have the aforementioned features, are in particular manifolds inside which the heat transfer liquid 6 circulates. According to the example illustrated, the second manifold 72 is a manifold for taking the heat transfer liquid 6 into the first heat exchange compartment 41, while the first manifold 71 is a manifold for discharging the heat transfer liquid 6 from the first heat exchange compartment 41. Likewise, the sixth manifold 76 is a manifold for taking the heat transfer liquid 6 into the second heat exchange compartment 42, while the fifth manifold 75 is a manifold for discharging the heat transfer liquid 6 from the second heat exchange compartment 42.

The second diameter D2 is larger than the fourth diameter D4 and the fifth diameter D5 is larger than the seventh diameter D7. The second manifold 72, the fourth manifold 74, the fifth manifold 75 and the seventh manifold 77, which originate from the orifices the diameters of which have the aforementioned features, are in particular manifolds inside which the refrigerant 4 circulates. According to the example illustrated, the fourth manifold 74 is a manifold for taking the refrigerant 4 into the first heat exchange compartment 41, while the second manifold 72 is a manifold for discharging the refrigerant 4 from the first heat exchange compartment 41. Likewise, the seventh manifold 77 is a manifold for taking the refrigerant 4 into the second heat exchange compartment 42, while the fifth manifold 75 is a manifold for discharging the refrigerant 4 from the second heat exchange compartment 42.

These arrangements are such that the heat transfer liquid 6 and the refrigerant 4 circulate counter-currently to each other inside the first heat exchange compartment 41 and the second heat exchange compartment 42. By reversing the direction of circulation of the heat transfer liquid 6 inside the first manifold 71 and the second manifold 72 and/or the fifth manifold 75 and the sixth manifold 76, a refrigerant/heat transfer liquid heat exchanger 10 is obtained inside which the heat transfer liquid 6 and the refrigerant 4 circulate co-currently with each other inside the first heat exchange compartment 41 and the second heat exchange compartment 42.

In FIGS. 14 to 17, a plurality of plates 105a, 105b, 105c, 105d, 105e, 105f are nested inside each other in contact with each other at least by means of their raised edge 107 and their groove 200, in order to jointly form the first heat exchange compartment 41 and the second heat exchange compartment 42. In other words, four exchange plates 105a, 105b, 105c, 105d, 105e, 105f are stacked on top of each other in a stacking direction D″ that is parallel to the axis Ox and perpendicular to the bottom plane P4. The exchange plates 105a, 105b, 105c, 105d, 105e, 105f form between them a space that forms the circulation chambers 211a, 211b, 221a, 221b for the refrigerant 4 or the heat transfer liquid 6.

In other words, the first circulation chambers 211a, 221a and the second circulation chambers 211b, 221b are stacked along the stacking direction D″. Each circulation chamber 211a, 211b, 221a, 221b is delimited at least by the bottoms 106 of two immediately adjacent plates 105a, 105b, 105c, 105d, 105e, 105f and by the groove 200 of one of these plates 105a, 105b, 105c, 105d, 105e, 105f.

The grooves 200 of two successive plates 105a, 105b, 105c, 105d, 105e, 105f are fitted into each other in order to provide a seal between the first heat exchange compartment 41 and the second heat exchange compartment 42. According to another embodiment, the grooves 200 of two successive plates 105a, 105b, 105c, 105d, 105e, 105f can be laterally offset from each other, a crown of a plate 105a, 105b, 105c, 105d, 105e, 105f then being in contact with the bottom 106 of the immediately successive plate 105a, 105b, 105c, 105d, 105e, 105f in order to provide a seal between the first heat exchange compartment 41 and the second heat exchange compartment 42.

In FIG. 16 more particularly, it will be noted that the recesses 113a, 113b of a plate of the third type 105c include a summit 118 that emerges from the bottom 106 of the plate of the third type 105c and that is in contact with the bottom of a plate of the fourth type 105d. Likewise, the recesses 113a, 113b of a plate of the fourth type 105d include a summit 118 that emerges from the bottom 106 of the plate of the fourth type 105d and that is in contact with the bottom of a plate of the third type 105c. It will be noted that these arrangements can transposed identically for the plates of the fifth type 105e and the plates of the sixth type 105f.

All of these arrangements are such that a method according to the present invention for cooling the component 1 using the installation 2 described above, and comprising a refrigerant/heat transfer liquid heat exchanger 10 shown in FIG. 6, makes it possible to cool the component 1, in two appropriate modes, depending on the charging state of the electrical storage device 1, and in particular on the basis of a choice of activation of the first control member 11 and/or the second control member 12 in which:

the refrigerant 4 and the heat transfer liquid 6 travel through the first heat exchange compartment 41 and the second heat exchange compartment 42 when the electrical storage device 1 is in a rapid charging mode;

the refrigerant 4 and the heat transfer liquid 6 travel through either one of the first heat exchange compartment 41 and the second heat exchange compartment 42 when the electrical storage device 1 is in a normal charging mode.

All of these arrangements are such that a method according to the present invention for cooling the component 1 using the installation 2 described above, and comprising a refrigerant/heat transfer liquid heat exchanger 10 shown in FIG. 7, makes it possible to cool the component 1, in three appropriate modes, depending on the charging state of the electrical storage device 1, and in particular on the basis of a choice of activation of the first control member 11 and/or the second control member 12 in which:

the refrigerant 4 and the heat transfer liquid 6 travel through the first heat exchange compartment 41 and the second heat exchange compartment 42 when the electrical storage device 1 is in a rapid charging mode;

the refrigerant 4 and the heat transfer liquid 6 travel through the first heat exchange compartment 41 only when the electrical storage device 1 is in a normal charging mode;

the refrigerant 4 and the heat transfer liquid 6 travel through the second heat exchange compartment 42 only when the electrical storage device 1 is in an intermediate charging mode.

1. A refrigerant/heat transfer liquid heat exchanger comprising:
at least one stack of plates defining at least two heat exchange compartments sealed from each other, namely a first heat exchange compartment that includes a first refrigerant circulation path and a first heat transfer liquid circulation path, and a second heat exchange compartment that includes a second refrigerant circulation path and a second heat transfer liquid circulation path,
wherein at least one of the circulation paths of the first heat exchange compartment and one of the circulation paths of the second heat exchange compartment are at least partially delimited by a single plate.

2. The refrigerant/heat transfer liquid heat exchanger as claimed in claim 1, wherein the first refrigerant circulation path includes a plurality of first refrigerant circulation chambers, the second refrigerant circulation path includes a plurality of second refrigerant circulation chambers, the first heat transfer liquid circulation path includes a plurality of first heat transfer liquid circulation chambers, the second heat transfer liquid circulation path includes a plurality of second heat transfer liquid circulation chambers, and a single plate jointly defines one of the first refrigerant circulation chambers, one of the second refrigerant circulation chambers, one of the first heat transfer liquid circulation chambers and one of the second heat transfer liquid circulation chambers.

3. The refrigerant/heat transfer liquid heat exchanger as claimed in claim 1, wherein, the refrigerant/heat transfer liquid heat exchanger comprises at least one manifold extending along a general axis of elongation that is parallel to a plane of separation jointly bordering the first heat exchange compartment and the second heat exchange compartment.

4. The refrigerant/heat transfer liquid heat exchanger as claimed in claim 3, wherein at least one of the heat exchange compartments comprises four manifolds.

5. The refrigerant/heat transfer liquid heat exchanger as claimed in claim 3, wherein at least one of the manifolds extends from one end to the other of one of the heat exchange compartments along its general axis of elongation, which intersects a bottom plane in which extends a bottom of the plate.

6. The refrigerant/heat transfer liquid heat exchanger as claimed in claim 1, wherein, the plate comprises at least one groove that sealably isolates the first heat exchange compartment and the second heat exchange compartment.

7. The refrigerant/heat transfer liquid heat exchanger as claimed in claim 6, wherein the first circulation chambers and the second circulation chambers are stacked along a stacking direction that is parallel to the general axis of elongation of the manifold, at least one circulation chamber being delimited by two immediately adjacent plates and at least the groove of one of these plates.

8. The refrigerant/heat transfer liquid heat exchanger as claimed in claim 6, wherein a refrigerant circulation chamber is interposed between two heat transfer liquid circulation chambers and in that a heat transfer liquid circulation chamber is interposed between two refrigerant circulation chambers.

9. The refrigerant/heat transfer liquid heat exchanger as claimed in claim 6, wherein each plate includes a raised edge formed by two longitudinal edges and two lateral edges and surrounding the bottom, which is provided with eight orifices.

10. The refrigerant/heat transfer liquid heat exchanger as claimed in claim 6, wherein the eight orifices comprise four orifices, a first orifice, a second orifice, a third orifice and a fourth orifice of which are arranged inside a first zone of the plate, and four other orifices, a fifth orifice, a sixth orifice, a seventh orifice and an eighth orifice of which are arranged inside a second zone of the plate the first zone and the second zone being separated from each other by the groove that originates from the bottom of the plate and that extends between a first lateral edge and a second lateral edge of the plate.

11. The refrigerant/heat transfer liquid heat exchanger as claimed in claim 10, wherein characterized in that the bottom of the plate is provided with at least one rib that extends inside the first zone and/or the second zone.

12. The refrigerant/heat transfer liquid heat exchanger as claimed in claim 11, wherein the rib is perpendicular to the groove.

13. The refrigerant/heat transfer liquid heat exchanger as claimed in claim 11, wherein the rib is parallel to the groove.

14. An installation for thermal treatment of a component provided on a motor vehicle, the installation comprising:
a refrigerant circuit;
a heat transfer liquid circuit; and
a refrigerant/heat transfer liquid heat exchanger as claimed in claim 1, the refrigerant circuit comprising a first refrigerant circulation branch and a second refrigerant circulation branch that are arranged parallel to each other, the heat transfer liquid circuit comprising a first heat transfer liquid circulation branch and a second heat transfer liquid circulation branch that are arranged parallel to each other,
wherein the first refrigerant circulation path constitutes the first refrigerant circulation branch, the first heat transfer liquid circulation path constitutes the first heat transfer liquid circulation branch, the second refrigerant circulation path constitutes the second refrigerant circulation branch and the second heat transfer liquid circulation path constitutes the second heat transfer liquid circulation branch.

15. A method for cooling an electrical storage device of a motor vehicle using an installation as claimed in claim 14, in which:
the refrigerant and the heat transfer liquid travel through the first heat exchange compartment and the second heat exchange compartment when the electrical storage device is in a rapid charging mode;
the refrigerant and the heat transfer liquid travel through the first heat exchange compartment only when the electrical storage device is in a normal charging mode; and
the refrigerant and the heat transfer liquid travel through the second heat exchange compartment only when the electrical storage device is in an intermediate charging mode.
